(19) United States
(12) Patent Application Publication
(10) Pub. No.: US 2006/0140244 A1
(43) Pub. Date: Jun. 29, 2006

(54) Extended length graphite electrode

(76) Inventor: Diane M. Artman, Westlake, OH (US)

Correspondence Address: WADDEY & PATTERSON, 1600 DIVISION STREET, SUITE 500, NASHVILLE, TN, 37203, US

(21) Appl. No.: 11/024,372

(22) Filed: Dec. 28, 2004

(51) Int. Cl. H05B 7/06

(52) U.S. Cl. 373/93

(57) ABSTRACT

An extended graphite electrode for use in an electric arc furnace facility, which includes joining at least two component graphite electrodes, at least one of which comprises a male tang having a ratio of male tang length to diameter of the electrode of at least about 0.60, to form a joined graphite electrode and transporting the joined graphite electric arc furnace facility.

### BACKGROUND OF THE INVENTION

1. Technical Field

The present invention relates to the production of graphite electrodes having a length greater than those capable of being produced by electrode manufacturing facilities. More particularly, the invention provides a graphite electrode to an electric arc furnace facility (i.e., a plant or other location at which one or more electric arc furnaces are operated) which reduces the number of electrode additions and joinders required to be made at the electric arc furnace facility.

2. Background Art

Graphite electrodes are used in the steel industry to melt the metals and other ingredients used to form steel in electrothermal furnaces. The heat needed to melt metals is generated by passing current through one or a plurality of electrodes, usually three, and forming an arc between the electrodes and the metal. Electrical currents in excess of 100,000 amperes are often used. The resulting high temperature melts the metals and other ingredients. Generally, the electrodes used in steel furnaces each consist of electrode columns, that is, a series of individual electrodes joined to form a single column. In this way, as electrodes are depleted during the thermal process, replacement electrodes can be joined to the column to maintain the length of the column extending into the furnace.

Conventionally, electrodes are joined into columns via a pin (sometimes referred to as a nipple) that functions to join the ends of adjoining electrodes. Typically, the pin takes the form of opposed male threaded sections or tangs, with at least one end of the electrodes comprising female threaded sections capable of mating with the male threaded section of the pin. Thus, when each of the opposing male threaded sections of a pin are threaded into female threaded sections in the ends of two electrodes, those electrodes become joined into an electrode column. Commonly, the joined ends of the adjoining electrodes, and the pin therebetween, are referred to in the art as a joint.

Alternatively, it has in the past been suggested that the electrodes be formed with a male threaded protrusion or tang machined into one end and a female threaded socket machined into the other end, such that the electrodes can be joined by threading the male tang of one electrode into the female socket of a second electrode, and thus form an electrode column. The joined ends of two adjoining electrodes in such an embodiment is referred to in the art as a male-female joint.

Electrodes have been added onto an electrode column by hoisting the new electrode (having a pin threaded into one of the sockets thereof) onto the top of the column, where the pin is then threaded into the socket of the uppermost electrode in the column. Likewise, when male-female joints have been attempted in the past, electrodes have been added onto an electrode column by hoisting the new electrode onto the top of the column, such that the male tang of the new electrode is threaded into the socket of the uppermost electrode in the column. Joining graphite electrodes to an electrode column in this manner (referred to as “on-furnace additions”) can be hazardous, since it requires workers to be above the arc furnace to ensure proper joinder of the new electrode to the column.

Alternatively, one or more electrodes are joined on the shop floor of the electric arc furnace facility by threading the pin threaded into one electrode socket into the socket of an adjoining electrode. The resulting joined electrodes can then be hoisted onto the electrode column in a furnace in the manner described above. Although the number of on-furnace additions is reduced by this method, it remains undesirable since it requires a great deal of effort on the part of the electric arc furnace staff to make the electrode joinder. Moreover, joined electrodes require clamping on the joint; however, conventional electrode joints cannot withstand the stress of clamping. More particularly, on an electric arc furnace, the current is supplied to the electrode through a contact pad inside a holder system which uses a clamping mechanism to hold the electrode in place. This clamping mechanism supplies a large amount of force and historically it has been necessary to not clamp on the joint since the large force the clamping mechanism exerts could damage the joint and lead to electrode failure.

In any event, reducing the number of on-furnace additions or shop floor joinders is desired by the operators of electric arc furnace facilities to reduce the down time occasioned by additions and joinders and reduce the hazards of such activities.

Conventionally, graphite electrodes are manufactured in nominal lengths, in accordance with standards established by the National Electrical Manufacturers Association (NEMA) in the United States and published in the NEMA Standards Publication CG 1-2001, Manufactured Graphite/Carbon Electrodes (2002),the International Electrotechnical Commission (IEC) in Europe and published in the International Standard, Third Edition, 1997-05 (1997), and the Japan Standards Association (JSA) in Japan and published in Japanese Industrial Standard JIS R 7201: 1997, Cylindrical Machined Graphite Electrodes (1998). In the standards set by each organization, electrodes are manufactured in lengths no greater than about 2700 millimeters (mm) in length, with an accepted variation of +/−150 mm or +/−195 mm depending on the standard employed (the original genesis of this length convention is unclear; however, the belief is that manufacture and/or transport of longer electrodes was viewed as impractical when the electric arc furnace industry was developing).

While it is desirable to produce longer electrodes in order to reduce the number on-furnace additions or shop floor joinders, the equipment used to manufacture graphite electrodes is such that production of graphite electrodes of lengths substantially greater than nominal lengths or substantially greater than 2700 mm (for instance, 2950 mm or greater) is not possible. Moreover, the re-tooling necessary to produce longer electrodes is not economically feasible.

What is desired, therefore, is a graphite electrode having a length substantially greater than 2700 mm, yet of sufficient strength and stability to permit transport to an electric arc furnace facility. It is also highly desirable to achieve these property benefits without requiring substantial re-tooling in graphite electrode manufacturing facilities.

### SUMMARY OF THE INVENTION

It is an aspect of the present invention to provide an extended length graphite electrode.

It is another aspect of the present invention to provide a graphite electrode which is substantially longer than 2700 mm.

It is yet another aspect of the present invention to provide a plurality of graphite electrodes which can be joined to form a graphite electrode of at least about 2950 mm, and which has the strength and stability required for transport of the extended electrode and clamping on the joint.

Still another aspect of the present invention is an extended graphite electrode which can be provided to an electric arc furnace facility and thus reduce the amount of on-furnace electrode adds or shop floor electrode joinders required.

These aspects and others that will become apparent to the artisan upon review of the following description can be accomplished by providing a method for producing an extended graphite electrode (preferably one having a length of at least nominal length plus 10%; more advantageously, at least about 2950 mm, most advantageously, at least about 3600 mm) for use at an electric arc furnace facility, comprising joining at least two component graphite electrodes, at least one of which comprises a male tang having a ratio of male tang length to diameter of the electrode of at least about 0.60, to form a joined graphite electrode and transporting the joined graphite electric arc furnace facility.

Advantageously, the ratio of the diameter of the male tang at its base to male tang length is no greater than about 2.5 times the ratio of male tang length to electrode diameter, and the ratio of the diameter of the male tang at its base to male tang length varies with the ratio of male tang length to electrode diameter such that for every 0.01 higher than 0.60 the ratio of male tang length to electrode diameter is, the ratio of the diameter of the male tang at its base to the ratio of male tang length to electrode diameter should be about 0.016 lower. In addition, for an electrode having a ratio of male tang length to electrode diameter of 0.85 or lower, the ratio of the taper of the male tang to the ratio of male tang length to electrode diameter should be at least about 15. The ratio of the taper of the male tang to the ratio of male tang length to electrode diameter ought to vary with the ratio of male tang length to electrode diameter such that for every 0.01 lower than 0.85 the ratio of male tang length to electrode diameter is, the ratio of the taper of the male tang to the ratio of male tang length to electrode diameter should be about 1.25 higher.

In another embodiment, the inventive method provides a process for preparing an extended graphite electrode for use in an electric arc furnace facility, the process including mixing coke and a pitch binder, to form a stock blend; extruding the stock blend to form a green stock; baking the green stock to form a carbonized stock; graphitizing the carbonized stock by maintaining the carbonized stock at a temperature of at least about 2500° C. to form a graphitized stock; machining the graphitized stock so as to form a male tang having a ratio of male tang length to diameter of the graphitized stock of at least about 0.60 to form a component graphite electrode; joining at least two component graphite electrodes to form a joined graphite electrode; and transporting the joined graphite electrode to an electric arc furnace facility.

It is to be understood that both the foregoing general description and the following detailed description provide embodiments of the invention and are intended to provide an overview or framework of understanding to nature and character of the invention as it is claimed. The accompanying drawings are included to provide a further understanding of the invention and are incorporated in and constitute a part of the specification. The drawings illustrate various embodiments of the invention and together with the description serve to describe the principles and operations of the invention.

### BRIEF DESCRIPTION OF THE DRAWINGS

FIG. 1 is a partial side cross-sectional view of a extended graphite electrode in accordance with the present invention.

FIG. 2 is a partial side cross-sectional view of a graphite electrode having a male tang for the extended graphite electrode of FIG. 1.

FIG. 3 is a partial side cross-sectional view of a female socket for the extended graphite electrode of FIG. 1.

### DETAILED DESCRIPTION OF THE PREFERRED EMBODIMENT

Graphite electrodes can be fabricated by first combining a particulate fraction comprising calcined coke, pitch and, optionally, mesophase pitch or PAN-based carbon fibers into a stock blend. More specifically, crushed, sized and milled calcined petroleum coke is mixed with a coal-tar pitch binder to form the blend. The particle size of the calcined coke is selected according to the end use of the article, and is within the skill in the art. Generally, particles up to about 25 millimeters (mm) in average diameter are employed in the blend. The particulate fraction preferable includes a small particle size filler comprising coke powder. Other additives that may be incorporated into the small particle size filler include iron oxides to inhibit puffing (caused by release of sulfur from its bond with carbon inside the coke particles), coke powder and oils or other lubricants to facilitate extrusion of the blend.

Most preferably, the carbon fibers (when used) are preferably present at a level of about 0.5 to about 6 parts by weight of carbon fibers per 100 parts by weight of calcined coke, or at about 0.4% to about 5.5% by weight of the total mix components (excluding binder). The preferred fibers have an average diameter of about 6 to about 15 microns, and a length of preferably about 4 mm to about 25 mm, and most preferably less than about 32 mm. The carbon fibers used in the inventive process should preferably have a tensile strength of at least about 150,000 psi. Most advantageously, the carbon fibers are added to the stock blend as bundles, each bundle containing from about 2000 to about 20,000 fibers.

Preferably, the fibers are added after mixing of the particulate fraction and pitch has already begun. Indeed, in a more preferred embodiment, the fibers are added after at least about half the mix cycle has been completed, most preferably after at least about three-quarters of the mix cycle has been completed. For instance, if the mixing of the particulate fraction and pitch takes two hours (i.e., a mix cycle is two hours), the fibers should be added after one hour, or even ninety minutes, of mixing. Adding the fibers after the mixing has begun will help preserve fiber length (which can be reduced during the mixing process) and thereby the beneficial effects of the inclusion of fibers, which are believed to be directly related to fiber length.

As noted above, the particulate fraction can include small particle size filler (small is used herein as compared to the particle size of the calcined coke, which generally has a diameter such that a major fraction of it passes through a 25 mm mesh screen but not a 0.25 mm mesh screen, and as compared to the fillers conventionally employed). More specifically, the small particle size filler comprises at least about 75% coke powder, by which is meant coke having a diameter such that at least about 70% and more advantageously up to about 90%, will pass through a 200 Tyler mesh screen, equivalent to 74 microns.

The small particle size filler can further comprise at least about 0.5% and up to about 25% of other additives like a puffing inhibitor such as iron oxide. Again, the additive should also be employed at a particle size smaller than that conventionally used. For instance, when iron oxide is included, the average diameter of the iron oxide particles should be such that they are smaller than about 10 microns. Another additional additive which can be employed is petroleum coke powder, having an average diameter such that they are smaller than about 10 microns, added to fill porosity of the article and thus enable better control of the amount of pitch binder used. The small particle size filler should comprise at least about 30%, and as high as about 50% or even 65% of the particulate fraction.

After the blend of particulate fraction, pitch binder, etc. is prepared, the body is formed (or shaped) by extrusion though a die or molded in conventional forming molds to form what is referred to as a green stock. The forming, whether through extrusion or molding, is conducted at a temperature close to the softening point of the pitch, usually about 100° C. or higher. The die or mold can form the article in substantially final form and size, although machining of the finished article is usually needed, at the very least to provide structure such as threads. The size of the green stock can vary; for electrodes the diameter can vary between about 220 mm and 700 mm.

After extrusion, the green stock is heat treated by baking at a temperature of between about 700° C. and about 1100° C., more preferably between about 800° C. and about 1000° C., to carbonize the pitch binder to solid pitch coke, to give the article permanency of form, high mechanical strength, good thermal conductivity, and comparatively low electrical resistance, and thus form a carbonized stock. The green stock is baked in the relative absence of air to avoid oxidation. Baking should be carried out at a rate of about 1° C. to about 5° C. rise per hour to the final temperature. After baking, the carbonized stock may be impregnated one or more times with coal tar or petroleum pitch, or other types of pitches or resins known in the industry, to deposit additional coke in any open pores of the stock. Each impregnation is then followed by an additional baking step.

After baking, the carbonized stock is then graphitized. Graphitization is by heat treatment at a final temperature of between about 2500° C. to about 3400° C. for a time sufficient to cause the carbon atoms in the coke and pitch coke binder to transform from a poorly ordered state into the crystalline structure of graphite. Advantageously, graphitization is performed by maintaining the carbonized stock at a temperature of at least about 2700° C., and more advantageously at a temperature of between about 2700° C. and about 3200° C. At these high temperatures, elements other than carbon are volatilized and escape as vapors. The time required for maintenance at the graphitization temperature using the process of the present invention is no more than about 18 hours, indeed, no more than about 12 hours. Preferably, graphitization is for about 1.5 to about 8 hours. Once graphitization is completed, the finished article can be cut to size and then machined or otherwise formed into its final configuration.

In order to provide a male-female electrode joint having improved stability so as to permit the formation of an extended electrode and allow clamping on the joint, the male tang (and, by extension, the female socket) must be dimensioned such that the tang will provide the required strength. In order to do so, a balancing must be accomplished. More particularly, it is now been discovered that the ratio of the length of the male tang to the diameter of the electrode (referred to herein as the tang factor) is important in facilitating the formation of an extended electrode. More specifically, a tang factor of at least about 0.60 is believed to be important in creating a male-female electrode joint having sufficiently improved stability.

The interaction of other characteristics can also help optimize the electrode. For instance, a ratio (referred to herein as the tang diameter factor) of a factor defined by the ratio of the diameter of the male tang at its base to the male tang length can be used to provide even further enhancements to the extended electrode. The tang diameter factor should be no greater than 2.5 times the tang factor for an especially effective electrode with a tang factor of about 0.60. Indeed, the tang diameter factor should most preferably vary with the tang factor, such that when an electrode with a tang factor higher than 0.60 is produced, the tang diameter factor of the electrode should be lower than 2.5 times the stub factor. More specifically, for every 0.01 higher than 0.60 that the tang factor of an electrode is, the maximum tang diameter factor should be about 0.016 lower. As an example, when an electrode having a tang factor of 0.85 is produced, the tang diameter factor of the male tang of the electrode should be lower than about 1.28 times the tang factor of the electrode.

Another characteristic that can come into play in designing an effective extended electrode is referred to herein as the taper factor, which is defined as the ratio of the taper (expressed in degrees, and illustrated in FIG. 2 as the angle designated a) of the male tang to the tang factor. The taper factor for an effective electrode should be at least about 15, where the tang factor is 0.85, and should also vary as electrodes with different tang factors are produced. For instance, for every 0.01 lower than 0.85 that the tang factor of an electrode is, the minimum taper factor should be about 1.25 higher. As an example, when an electrode having a tang factor of 0.60 is produced, the taper factor of the male tang of the electrode should be at least about 45.

Once the graphite electrode is prepared, two or more are joined so as to form an extended graphite electrode having a length greater than the lengths of either of the component electrodes used to form the extended electrode. More particularly, the length of the extended electrode is at least the nominal length as established by one or more of NEMA, IEC and JSA, plus 10%, more preferably plus 15%. In another embodiment, the inventive extended electrode is substantially greater than about 2700 mm (the longest of the nominal lengths), more preferably at least about 2950 mm. In a most preferred embodiment, the extended electrode is at least about 3600 mm in length. The joining of the electrodes to form an extended electrode takes place at a location remote from the electric arc furnace facility. For instance, the component electrodes can be joined at the electrode manufacturing facility, or at some location intermediate the electrode manufacturing facility and the electric arc furnace facility.

When employing the tang factor of at least about 0.60, and/or the tang diameter factor or taper factor of the component electrodes used to form the inventive extended electrode as described above, an extended electrode is produced that can be transported without fracture or other undesirable effects, and yet is longer than conventional electrodes and can withstand the forces of clamping on the joint, thus reducing on-furnace adds or electric arc furnace shop floor joinders.

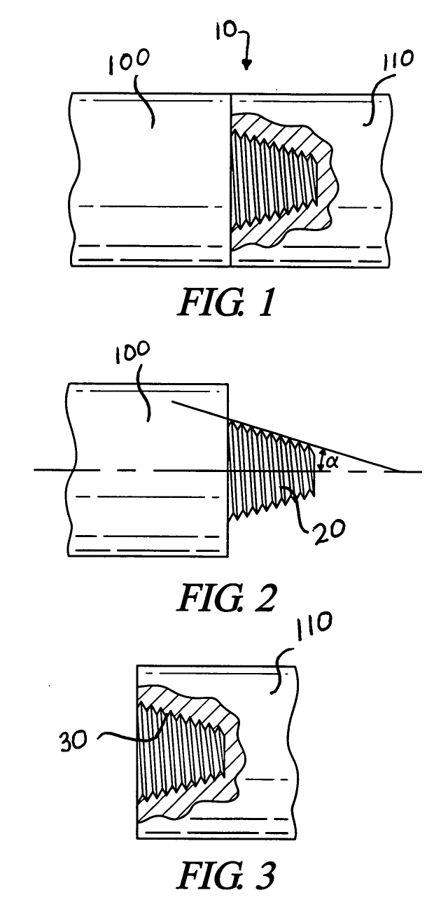

A typical extended graphite electrode produced in accordance with the invention is illustrated in FIGS. 1 and 2 and denoted 10. Extended electrode 10 comprises a first electrode 100 and a second electrode 110, first electrode 100 having a male tang 20 and second electrode 110 having a female socket 30. As illustrated, male tang 20 and female socket 30 cooperate to form a joint 40 and thus connect first electrode 100 and second electrode 110 into extended electrode 10. With proper dimensioning of male tang 20 (and corresponding dimensioning of female socket 30), an extended electrode 10 which can be produced and successfully transported to an electric arc furnace facility is provided.

The disclosures of all cited patents and publications referred to in this application are incorporated herein by reference.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A method for producing an extended graphite electrode for use at an electric arc furnace facility, comprising joining at least two component graphite electrodes, at least one of which comprises a male tang having a ratio of male tang length to diameter of the electrode of at least about 0.60, to form a joined graphite electrode and transporting the joined graphite electric arc furnace facility.

2. The method of claim 1, wherein the extended graphite electrode has a length of at least nominal length plus 10%.

3. The method of claim 2, wherein the extended electrode has a length of at least nominal length plus 15%.

4. The method of claim 1, wherein the extended electrode has a length of at least about 2950 mm.

5. The method of claim 4, wherein the extended electrode has a length of at least about 3600 mm.

6. The method of claim 1, wherein the ratio of the diameter of the male tang at its base to male tang length is no greater than about 2.5 times the ratio of male tang length to electrode diameter.

7. The method of claim 6, wherein the ratio of the diameter of the male tang at its base to male tang length varies with the ratio of male tang length to electrode diameter such that for every 0.01 higher than 0.60 the ratio of male tang length to electrode diameter is, the ratio of the diameter of the male tang at its base to the ratio of male tang length to electrode diameter should be about 0.016 lower.

8. The method of claim 1, wherein for an electrode having a ratio of male tang length to electrode diameter of 0.85 or lower, the ratio of the taper of the male tang to the ratio of male tang length to electrode diameter is at least about 15.

9. The method of claim 8, wherein the ratio of the taper of the male tang to the ratio of male tang length to electrode diameter varies with the ratio of male tang length to electrode diameter such that for every 0.01 lower than 0.85 the ratio of male tang length to electrode diameter is, the ratio of the taper of the male tang to the ratio of male tang length to electrode diameter should be about 1.25 higher.

10. A method for preparing an extended graphite electrode for use in an electric arc furnace facility, the process comprising
(a) mixing coke and a pitch binder, to form a stock blend;
(b) extruding the stock blend to form a green stock;
(c) baking the green stock to form a carbonized stock;
(d) graphitizing the carbonized stock by maintaining the carbonized stock at a temperature of at least about 2500° C. to form a graphitized stock;
(e) machining the graphitized stock so as to form a male tang having a ratio of male tang length to diameter of the graphitized stock of at least about 0.60 to form a component graphite electrode;
(f) joining at least two component graphite electrodes to form a joined graphite electrode; and
(g) transporting the joined graphite electrode to an electric arc furnace facility.

11. The method of claim 10, wherein the extended graphite electrode has a length of at least nominal length plus 10%.

12. The method of claim 11, wherein the extended electrode has a length of at least nominal length plus 15%.

13. The method of claim 10, wherein the extended electrode has a length of at least about 2950 mm.

14. The method of claim 13, wherein the extended electrode has a length of at least about 3600 mm.

15. The method of claim 10, wherein the ratio of the diameter of the male tang at its base to male tang length is no greater than about 2.5 times the ratio of male tang length to electrode diameter.

16. The method of claim 15, wherein the ratio of the diameter of the male tang at its base to male tang length varies with the ratio of male tang length to electrode diameter such that for every 0.01 higher than 0.60 the ratio of male tang length to electrode diameter is, the ratio of the diameter of the male tang at its base to the ratio of male tang length to electrode diameter should be about 0.016 lower.

17. The method of claim 10, wherein for an electrode having a ratio of male tang length to electrode diameter of 0.85 or lower, the ratio of the taper of the male tang to the ratio of male tang length to electrode diameter is at least about 15.

18. The method of claim 17, wherein the ratio of the taper of the male tang to the ratio of male tang length to electrode diameter varies with the ratio of male tang length to electrode diameter such that for every 0.01 lower than 0.85 the ratio of male tang length to electrode diameter is, the ratio of the taper of the male tang to the ratio of male tang length to electrode diameter should be about 1.25 higher.
